(19) United States
(12) Patent Application Publication
(10) Pub. No.: US 2014/0280016 A1
(43) Pub. Date: Sep. 18, 2014

(54) AUTOCOMPLETE-BASED ADVERTISEMENTS

(71) Applicants: Hugh Evan Williams, Los Gatos, CA (US); Sathishwar Pottavathini, Dublin, CA (US); Qing Li, Sunnyvale, CA (US); Harish Narayanappa, Santa Clara, CA (US)

(72) Inventors: Hugh Evan Williams, Los Gatos, CA (US); Sathishwar Pottavathini, Dublin, CA (US); Qing Li, Sunnyvale, CA (US); Harish Narayanappa, Santa Clara, CA (US)

(21) Appl. No.: 14/143,247

(22) Filed: Dec. 30, 2013

Related U.S. Application Data
(60) Provisional application No. 61/800,539, filed on Mar. 15, 2013.

(51) Int. Cl. G06F 17/30

(52) U.S. Cl. CPC G06F 17/30867
USPC 707/710

(57) ABSTRACT

A system and method of providing advertisements based on autocomplete functionality are disclosed. In some embodiments, user-entered text is received in a search field of a search engine. A predicted query is determined based on the user-entered text. The predicted query comprises predicted text and at least a portion of the user-entered text, the predicted text being absent from the user-entered text. An advertisement for an item is determined based on the predicted query. The advertisement is caused to be displayed to the user concurrently with the predicted query being displayed in an autocomplete user interface element of the search field. In some embodiments, the advertisement for the item comprises an identification of the item and a price of the item.

### CROSS-REFERENCE TO RELATED APPLICATIONS

This application claims priority to U.S. Provisional Application No. 61/800,539, filed on Mar. 15, 2013, entitled, “ITEM LISTINGS IN AUTO-FILL LIST,” which is hereby incorporated by reference in its entirety as if set forth herein.

### TECHNICAL FIELD

The present application relates generally to the technical field of data processing, and, in various embodiments, to systems and methods of providing advertisements based on autocomplete functionality.

### BACKGROUND

Presenting relevant advertisements to users of a search engine in an effective way that leads to high conversion rates is challenging. This challenge is made even more difficult when dealing with the issues of latency and limited display space that plague mobile devices.

### BRIEF DESCRIPTION OF THE DRAWINGS

Some embodiments of the present disclosure are illustrated by way of example and not limitation in the figures of the accompanying drawings, in which like reference numbers indicate similar elements and in which:

FIG. 1 is a block diagram depicting a network architecture of a system, according to some embodiments, having a client-server architecture configured for exchanging data over a network;

FIG. 2 is a block diagram depicting a various components of a network-based publisher, according to some embodiments;

FIG. 3 is a block diagram depicting an example embodiment of various tables that may be maintained within a database;

FIG. 4 illustrates a search page on which autocomplete-based advertisements are provided, in accordance with some embodiments;

FIG. 5 illustrates a search page on which autocomplete-based advertisements are provided within an autocomplete user interface element, in accordance with some embodiments;

FIG. 6 is a flowchart illustrating a method of providing autocomplete-based advertisements, in accordance with some embodiments; and

FIG. 7 shows a diagrammatic representation of a machine in the example form of a computer system within which a set of instructions may be executed to cause the machine to perform any one or more of the methodologies discussed herein, in accordance with some embodiments.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

In some embodiments, user-entered text is received in a search field for a search engine. A predicted query can be determined based on the user-entered text. The predicted query can comprise predicted text and at least a portion of the user-entered text, and the predicted text can be absent from the user-entered text. An advertisement can be determined for an item based on the predicted query. The advertisement can be caused to be displayed to the user concurrently with the predicted query being displayed in an autocomplete user interface element for the search field.

In some embodiments, the advertisement for the item comprises an identification of the item and a price of the item. In some embodiments, causing the advertisement to be displayed comprises causing the advertisement to be displayed in the autocomplete user interface element for the search field concurrently with the predicted query. In some embodiments, the advertisement comprises a selectable link to an item listing page, where the item listing page is configured to enable a user to initiate submitting a purchase request or a bid request for the item. In some embodiments, the advertisement is configured to enable a user to submit a purchase request or a bid request for the item. In some embodiments, the autocomplete user interface element comprises an autocomplete box extending from the search field.

In some embodiments, determining the predicted query is further based on at least one of a browsing history of the user, a purchase history of the user, a bidding history of the user, and context information regarding a context in which the user is providing the user-entered text. In some embodiments, determining the advertisement is further based on at least one of a browsing history of the user, a purchase history of the user, a bidding history of the user, and context information regarding a context in which the user is providing the user-entered text.

In some embodiments, a modified version of the user-entered text can be received in the search field. The modified version can comprise an addition of text to the user-entered text or a deletion of text from the user-entered text. A subsequent predicted query can be determined based on the modified version of the user-entered text. The subsequent predicted query can comprise the modified version of the user-entered text and subsequent predicted text absent from the modified version of the user-entered text. A subsequent advertisement for a subsequent item can be determined based on the subsequent predicted query. The subsequent advertisement can be caused to be displayed concurrently with the subsequent predicted query being displayed in the autocomplete user interface element for the search field.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

FIG. 2 is a block diagram illustrating multiple marketplace and payment applications 120 and 122 that, in one example embodiment, are provided as part of the networked system 102. Alternate solutions may include other combinations of these modules. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may, furthermore, access one or more databases 126 via the database servers 124. The slide checkout mechanism disclosed herein may be integrated with any or all of the applications described hereinbelow. Some examples of such integration are provided; however, other applications may also have integrations consistent with this disclosure.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller. The store applications 206 may support an online webstore, such as a hosted solution, where the webstore integrates with the slide checkout mechanism to enable users to easily use the webstore application on a mobile device, wherein the item and item identifier are provided by the store. According to some embodiments, the slide checkout cursor is configured according to input from the store, such as where the cursor is designed and presented to the user having the look and feel of the store. Further, the organization of the information presented to the user may be specific to the store.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (e.g., through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page on which information regarding transactions to which the user is (or has been) a party may be viewed. Further, a personalization application 210 may enable a user to personalize listings and other aspects of their interactions with the networked system 102 and other parties. The personalization application(s) 210 may integrate with the slide checkout mechanism such that the user's information is used to generate the selections and options available. In some embodiments, the user is able to specify their preferences, such as incorporate specific payment options, addresses and other considerations. For example, the user may specify that when a particular shipping address is selected, then a selection to identify the item as a gift will be presented on the display; when the user slides over the gift option, a gift receipt is provided with the item, or a gift card is provided with the item.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may, accordingly, include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116. The internationalization applications 212 may integrate with the slide checkout mechanism to provide specific configurations for a geographical area. For example, in Japan, the display may provide the various selection items from right to left, consistent with the reading order for Japanese consumers.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make the listings available via the networked system 102, as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such as, for example, messages advising users regarding the status of listings at the networked system 102 (e.g., providing “outbid” notices to bidders during an auction process or to providing promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

FIG. 3 is a high-level entity-relationship diagram, illustrating various tables 300 that may be maintained within the database(s) 126, and that are utilized by and support the applications 120 and 122. A user table 302 contains a record for each registered user of the networked system 102, and may include identifier, address and financial instrument information pertaining to each such registered user. A user may operate as a seller, a buyer, or both, within the networked system 102. In one example embodiment, a buyer may be a user that has accumulated value (e.g., commercial or proprietary currency), and is accordingly able to exchange the accumulated value for items that are offered for sale by the networked system 102.

The tables 300 also include an items table 304 in which are maintained item records for goods and services that are available to be, or have been, transacted via the networked system 102. Each item record within the items table 304 may furthermore be linked to one or more user records within the user table 302, so as to associate a seller and one or more actual or potential buyers with each item record.

A transaction table 306 contains a record for each transaction (e.g., a purchase or sale transaction) pertaining to items for which records exist within the items table 304.

An order table 308 is populated with order records, each order record being associated with an order. Each order, in turn, may be associated with one or more transactions for which records exist within the transaction table 306.

Bid records within a bids table 310 each relate to a bid received at the networked system 102 in connection with an auction-format listing supported by an auction application 202. A feedback table 312 is utilized by one or more reputation applications 208, in one example embodiment, to construct and maintain reputation information concerning users. A history table 314 maintains a history of transactions to which a user has been a party. One or more attributes tables 316 record attribute information pertaining to items for which records exist within the items table 304. Considering only a single example of such an attribute, the attributes tables 316 may indicate a currency attribute associated with a particular item, the currency attribute identifying the currency of a price for the relevant item as specified by a seller.

Referring back to FIG. 2, an autocomplete advertising module 234 may be configured to perform any combination of functions related to providing advertisements based on autocomplete functionality disclosed herein, such as discussed below with respect to FIGS. 4-6. Although autocomplete advertising module 234 is shown in FIG. 2 as being incorporated into marketplace and payment applications 120 and 122, it is contemplated that other configurations are also within the scope of the present disclosure.

FIG. 4 illustrates a search page 400 on which autocomplete-based advertisements are provided, in accordance with some embodiments. Search page 400 can provide a graphical user interface for the services of a corresponding search engine. In some embodiments, the corresponding search engine comprises a general purpose search engine configured to perform a search of all searchable websites on the World Wide Web. Examples of a general purpose search engine include, but are not limited to, the web search engines used at http://www.google.com and http://www.yahoo.com. In some embodiments, the corresponding search engine comprises a specific purpose search engine configured to perform a search only of a limited number of websites, such as only the website on which it resides. Examples of specific purpose search engines include, but are not limited to, a search engine on an e-commerce website that only searches through the e-commerce website's own content (e.g., searching for an item on http://www.ebay.com), without the search extending beyond that e-commerce website.

Search page 400 can comprise a search field 420 within which user-entered text 410 (e.g., “sam” in FIG. 4) can be received. Autocomplete advertising module 234 can be configured to receive the user-entered text 420 in the search field 420, and to perform an autocomplete function for the user-entered text 410. Autocomplete is a feature that automatically predicts remaining characters of a word or phrase based on what has been input or typed so far. Autocomplete advertising module 234 can perform autocomplete on the user-entered text 410 to determine one or more predicted queries 430 (e.g., “samsonite”, “samsung”, and “sam's club” in FIG. 4) based on the user-entered text 410. The predicted queries 430 can comprise at least a portion of the user-entered text 410, as well as predicted text 435. The predicted queries 430 shown in FIG. 4 each comprise the user-entered text 410 “sam”, as well as predicted text 435, such as “sonite” for “samsonite”, “sung” for “samsung”, and “'s club” for “sam's club.” In some embodiments, the predicted text is absent from the user-entered text. Autocomplete advertising module 234 can be configured to determine and display the predicted queries 430 in an autocomplete user interface element 440 for the search field 420 prior to any user-instructed submission to the search engine, such as the user selecting (e.g., clicking or tapping) a selectable “Search” button 425 or providing input corresponding to an enter/return command. The user can provide an instruction for submitting the user-entered text 410 for search. Additionally, the user can provide an instruction for submitting any of the predicted queries 430 for search, such as by selecting (e.g., clicking or tapping) any one of them.

In some embodiments, the autocomplete user interface element 440 comprises an autocomplete box extending from the search field 420. Other configurations of the autocomplete user interface element 440 are also within the scope of the present disclosure.

In some embodiments, the determination of the predicted queries 430 can be further based on any combination of one or more of a variety of different signals. These signals can be obtained from the database(s) 126 in FIG. 1. However, it is contemplated that other sources of the signals are also within the scope of the present disclosure.

One signal can be a browsing history of the user entering the user-entered text 410. For example, if the user has a history of viewing Samsonite items or items in the luggage category, then the autocomplete advertising module 234 can use this information to determine that the user is intending to search for Samsonite items, and thus determine “samsonite” to be the intended search query rather than some other search query comprising the user-entered text 410 that is not related to luggage at all. The autocomplete advertising module 234 can also use this search context signal to display the predicted query “samsonite” in a more prominent position (e.g., in a higher position) than other predicted queries 430.

Another signal can be a purchase history of the user or a bidding history of the user. For example, if the user has a history of purchasing or bidding on Samsonite items or items in the luggage category, then the autocomplete advertising module 234 can use this information to determine that the user is intending to search for Samsonite items, and thus determine “samsonite” to be the intended search query rather than some other search query comprising the user-entered text 410 that is not related to luggage at all. The autocomplete advertising module 234 can also use this search context signal to display the predicted query “samsonite” in a more prominent position (e.g., in a higher position) than other predicted queries 430.

Yet another signal can be context information regarding a context in which the user is providing the user-entered text 410. For example, if the user has specified a search in a particular category just prior to entering the user-entered text 410, then the specification of that particular category can be used as a signal. In one example, if the user has specified that he would like to perform a search in a luggage category, then the autocomplete advertising module 234 can use this information to determine that the user is intending to search for Samsonite items, since Samsonite is a known luggage manufacturer and retailer, and thus determine “samsonite” to be the intended search query rather than some other search query comprising the user-entered text 410 that is not related to luggage at all. The autocomplete advertising module 234 can also use this search context signal to display the predicted query “samsonite” in a more prominent position (e.g., in a higher position) than other predicted queries 430.

The autocomplete advertising module 234 can be configured to determine one or more advertisements 450 based on the one or more predicted queries 430. Each advertisement 450 can be for an item being offered for sale. In some embodiments, the item is offered for sale on a website of the search page 400. For example, the item can be offered for sale the same e-commerce site on which the search page 400 resides. In some embodiments, the item is offered for sale on a different website than that of the search page 400. For example, the item can be offered for sale on an e-commerce site that is different from a general purpose search engine site of the search page 400. The autocomplete advertising module 234 can determine advertisements 450 by accessing and retrieving information from an ad server or a database of information on item listings (e.g., database(s) 126 in FIG. 1). Other configurations are also within the scope of the present disclosure.

In some embodiments, the determination of the advertisement is further based on any combination of one or more of a variety of different signals, including, but not limited to the signals discussed above. These signals can be obtained from the database(s) 126 in FIG. 1. However, it is contemplated that other sources of the signals are also within the scope of the present disclosure. These signals can be used to determine what advertisements to display. Additionally, these signals can be used to determine the placement or positioning of the advertisements on the search page 400. For example, if the user has a history of purchasing more Samsonite items than Samsung items, then the autocomplete advertising module 234 can cause an advertisement 450 for a Samsonite item to be displayed in a more prominent position (e.g., higher up on the search page 400) than an advertisement 450 for a Samsung item.

In some embodiments, the advertisement 450 comprises an identification (ID) 452 of the item and/or a price 454 of the item. The item ID 452 can comprise any indication that can be used to identify the item. Examples of an item ID 452 can include, but are not limited to, a name, brand, title, identification number, description, or image of the item. Other types of item ID's are also within the scope of the present disclosure.

In some embodiments, the advertisement 450 comprises a selectable link to an item listing page, such as a view item page. The item listing page can be configured to enable a user to initiate submitting a purchase request or a bid request for the item. In some embodiments, the advertisement 450 itself can be configured to enable a user to submit a purchase request or a bid request for the item. For example, the advertisement 450 can comprise a selectable user interface element 456 configured to submit a request to purchase the item of the advertisement 450 or to begin the process for submission of such a request upon its selection by the user. The advertisement 450 can also comprise a selectable user interface element 458 configured to submit a request to bid on the item of the advertisement 450 or to begin the process for submission of such a request upon its selection by the user. A bid field 459 can be provided to enable the user to enter a bid price for submission.

In some embodiments, the advertisement 450 comprises a graphical and/or textual advertisement 455 that links to another webpage. In some embodiments, this other webpage comprises an item being offered for sale. In some embodiments, this other webpage does not comprise an item being offered for sale, and may simply comprise a general advertisement for a company or brand.

In some embodiments, the autocomplete advertising module 234 is configured to cause the determined advertisement(s) 450 to be displayed to the user concurrently with the predicted queries 430 being displayed in the autocomplete user interface element 440 for the search field 420 prior to the user providing any instruction for submission of the user-entered text 410 or any of the predicted queries 430.

In some embodiments, the user can modify the user-entered text 410 within the search field 420 prior to or subsequent to providing an instruction to submit the user-entered text 410 for search by the search engine. Accordingly, a modified version of the user-entered text 410 can be received in the search field 420. The modified version can comprise an addition of text to the user-entered text 410 or a deletion of text from the user-entered text 410. As a result, one or more subsequent predicted queries 430 can be determined based on the modified version of the user-entered text 410 the same way the previous predicted queries 430 were determined based on the previous version of the user-entered text 410. The subsequent predicted queries 430 can comprise the modified version of the user-entered text 410 and subsequent predicted text 435 absent from the modified version of the user-entered text 410. One or more subsequent advertisements 450 for a subsequent item can be determined based on the one or more subsequent predicted queries 450, similar to the determination of the previous advertisements 450. The subsequent advertisement(s) 450 can be caused to be displayed concurrently with the one or more subsequent predicted queries 430 being displayed in the autocomplete user interface element 440 for the search field 420.

One or more search results 465 generated by the search engine of the search page 400 can be presented in a search results section 460 of the search page 400. In some embodiments, the search results 465 can be generated and presented based on and in response to a user-instructed submission of the user-entered text 410 or one of the predicted queries 430. In some embodiments, the search results 465 can be generated and presented prior to a user-instructed submission of the user-entered text 410 or one of the predicted queries 430, such as in response to and based on a detection of the user-entered text 410 or a determination of one of the predicted queries 430. Other configurations are also within the scope of the present disclosure.

In some embodiments, the autocomplete advertising module 234 is configured to cause the advertisement(s) 450 to be displayed in the autocomplete user interface element 440 for the search field 440 concurrently with the predicted queries 430. FIG. 5 illustrates one example of an autocomplete-based advertisement 450 being provided within the autocomplete user interface element 440. Although FIG. 5 shows the advertisement 450 displayed at the bottom of the user interface element 440, it is contemplated that other configurations are within the present disclosure. As previously discussed, the autocomplete advertising module 234 can be configured to cause the advertisement(s) 450 to be displayed in the autocomplete user interface element 440 for the search field 440 concurrently with the predicted queries 430 prior to any user-instructed submission (e.g., selection of “Search” button 425) of the user-entered text 410 or any of the predicted queries 430 for search.

The advertisement(s) 450 displayed in the autocomplete user interface element 440 can comprise any combination of one or more of the features previously discussed, such as an identification 452 of the corresponding item, a price 454 of the corresponding item, a selectable user interface element 456 configured to submit a request to purchase the item of the advertisement 450 or to begin the process for submission of such a request upon its selection by the user, a selectable user interface element 458 configured to submit a request to bid on the item of the advertisement 450 or to begin the process for submission of such a request upon its selection by the user, and a bid field 459 configured to enable the user to enter a bid price for submission. Other features and configurations of the advertisement(s) 450 are also within the scope of the present disclosure.

FIG. 6 is a flowchart illustrating a method of providing autocomplete-based advertisements, in accordance with some embodiments. The operations of method 600 may be performed by a system or modules of a system (e.g., autocomplete advertising module 234 in FIG. 2).

At operation 610, user-entered text 410 can be received from a user in a search field 420 for a search engine. At operation 620, a predicted query 430 can be determined based on the user-entered text 410. The predicted query 430 can comprise predicted text 435 and at least a portion of the user-entered text 410, and the predicted text 435 can be absent from the user-entered text 410. In some embodiments, the determination of the predicted query 430 is further based on any combination of one or more of a browsing history of the user, a purchase history of the user, a bidding history of the user, and context information regarding a context in which the user is providing the user-entered text 410. At operation 630, an advertisement 450 can be determined for an item based on the predicted query 430. In some embodiments, the determination of the advertisement 450 is further based on any combination of one or more of a browsing history of the user, a purchase history of the user, a bidding history of the user, and context information regarding a context in which the user is providing the user-entered text 410. At operation 640, the advertisement 450 can be caused to be displayed to the user concurrently with the predicted query 430 being displayed in an autocomplete user interface element 440 for the search field 420. In some embodiments, the advertisement 450 is displayed within the autocomplete user interface element 440.

At operation 650, a determination is made as to whether there has been a modification to the user-entered text 410 within the search field 420. If it is determined that there has been a modification to the user-entered text 410, then the method 600 returns to operation 620, where the modified version of the user-entered text 410 is used to determine a predicted query 430. If it is determined, at operation 650, that there has not been a modification to the user-entered text 410, then, at operation 660, a user-instructed submission of the user-entered text 410 or the predicted query 430 for search by the search engine can be received. It is contemplated that the operations of method 600 may incorporate any of the other features disclosed herein.

It is contemplated that any of the features and/or embodiments discussed herein may be combined or incorporated into any of the other features and/or embodiments.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 7 is a block diagram of a machine in the example form of a computer system 700 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a user interface (UI) navigation (or cursor control) device 714 (e.g., a mouse), a disk drive unit 716, a signal generation device 718 (e.g., a speaker) and a network interface device 720.

### Machine-Readable Medium

The disk drive unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media. The instructions 724 may also reside, completely or at least partially, within the static memory 706.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
receiving, from a user, user-entered text in a search field of a search engine;
determining a predicted query based on the user-entered text, the predicted query comprising predicted text and at least a portion of the user-entered text, the predicted text being absent from the user-entered text;
determining an advertisement for an item based on the predicted query; and
causing, by a machine having a memory and at least one processor, the advertisement to be displayed to the user concurrently with the predicted query being displayed in an autocomplete user interface element of the search field.

2. The computer-implemented method of claim 1, wherein the advertisement for the item comprises an identification of the item and a price of the item.

3. The computer-implemented method of claim 1, wherein causing the advertisement to be displayed comprises causing the advertisement to be displayed in the autocomplete user interface element for the search field concurrently with the predicted query.

4. The computer-implemented method of claim 1, wherein the advertisement comprises a selectable link to an item listing page, the item listing page being configured to enable a user to initiate submitting a purchase request or a bid request for the item.

5. The computer-implemented method of claim 1, wherein the advertisement is configured to enable the user to submit a purchase request or a bid request for the item.

6. The computer-implemented method of claim 1, wherein the autocomplete user interface element comprises an autocomplete box extending from the search field.

7. The computer-implemented method of claim 1, wherein determining the predicted query is further based on at least one of a browsing history of the user, a purchase history of the user, a bidding history of the user, and context information describing a context in which the user is providing the user-entered text.

8. The computer-implemented method of claim 1, wherein determining the advertisement is further based on at least one of a browsing history of the user, a purchase history of the user, a bidding history of the user, and context information describing a context in which the user is providing the user-entered text.

9. The computer-implemented method of claim 1, further comprising:
receiving, from the user, a modified version of the user-entered text in the search field, the modified version comprising an addition of text to the user-entered text or a deletion of text from the user-entered text;
determining a subsequent predicted query based on the modified version of the user-entered text, the subsequent predicted query comprising the modified version of the user-entered text and subsequent predicted text absent from the modified version of the user-entered text;
determining a subsequent advertisement for a subsequent item based on the subsequent predicted query; and
causing the subsequent advertisement to be displayed concurrently with the subsequent predicted query being displayed in the autocomplete user interface element of the search field.

10. A system comprising:
a machine having a memory and at least one processor; and
an autocomplete advertising module, executable by the at least one processor, configured to:
receive, from a user, user-entered text in a search field of a search engine;
determine a predicted query based on the user-entered text, the predicted query comprising predicted text and at least a portion of the user-entered text, the predicted text being absent from the user-entered text;
determine an advertisement for an item based on the predicted query; and
cause the advertisement to be displayed to the user concurrently with the predicted query being displayed in an autocomplete user interface element of the search field.

11. The system of claim 10, wherein the advertisement for the item comprises an identification of the item and a price of the item.

12. The system of claim 10, wherein the autocomplete advertising module is configured to cause the advertisement to be displayed in the autocomplete user interface element of the search field concurrently with the predicted query.

13. The system of claim 10, wherein the advertisement comprises a selectable link to an item listing page, the item listing page being configured to enable a user to initiate submitting a purchase request or a bid request for the item.

14. The system of claim 10, wherein the advertisement is configured to enable the user to submit a purchase request or a bid request for the item.

15. The system of claim 10, wherein the autocomplete user interface element comprises an autocomplete box extending from the search field.

16. The system of claim 10, wherein determining the predicted query is further based on at least one of a browsing history of the user, a purchase history of the user, a bidding history of the user, and context information describing a context in which the user is providing the user-entered text.

17. The system of claim 10, wherein determining the advertisement is further based on at least one of a browsing history of the user, a purchase history of the user, a bidding history of the user, and context information describing a context in which the user is providing the user-entered text.

18. The system of claim 10, wherein the autocomplete advertising module is further configured to:
receive, from the user, a modified version of the user-entered text in the search field, the modified version comprising an addition of text to the user-entered text or a deletion of text from the user-entered text;
determine a subsequent predicted query based on the modified version of the user-entered text, the subsequent predicted query comprising the modified version of the user-entered text and subsequent predicted text absent from the modified version of the user-entered text;
determine a subsequent advertisement for a subsequent item based on the subsequent predicted query; and
cause the subsequent advertisement to be displayed concurrently with the subsequent predicted query being displayed in the autocomplete user interface element of the search field.

19. A non-transitory machine-readable storage device storing a set of instructions that, when executed by at least one processor, causes the at least one processor to perform a set of operations comprising:
receiving, from a user, user-entered text in a search field of a search engine;
determining a predicted query based on the user-entered text, the predicted query comprising predicted text and at least a portion of the user-entered text, the predicted text being absent from the user-entered text;
determining an advertisement for an item based on the predicted query; and
causing the advertisement to be displayed to the user concurrently with the predicted query being displayed in an autocomplete user interface element of the search field.

20. The storage device of claim 19, wherein causing the advertisement to be displayed comprises causing the advertisement to be displayed in the autocomplete user interface element for the search field concurrently with the predicted query.
